(19) United States
(12) Patent Application Publication
(10) Pub. No.: US 2022/0292748 A1
(43) Pub. Date: Sep. 15, 2022

(54) Imagery keepsake generation

(71) Applicant: Photo Butler Inc., Easton, MA (US)

(72) Inventors: David Benaim, Newton Centre, MA (US); Richard Curtis, Marblehead, MA (US); Drew Spencer, Garden Grove, CA (US); Gerald Hewes, Lexington, MA (US); Andrew P. Goldfarb, Brookline, MA (US)

(21) Appl. No.: 17/634,324

(22) PCT Filed: Sep. 2, 2020
(86) PCT No.: PCT/US20/48976

§ 371 Date: Feb. 10, 2022

Related U.S. Application Data
(60) Provisional application No. 62/898,351, filed on Sep. 10, 2019.

(51) Int. Cl. G06T 11/60

(52) U.S. Cl. CPC G06T 11/60; G06T 2200/24

(57) ABSTRACT

Methods and systems for presenting imagery. The methods involve receiving at an interface at least one imagery item and a selection of a template. The methods then involve presenting to a viewer a preview of the at least one imagery item integrated in the selected template prior to rendering of the at least one imagery item in the template, receiving confirmation of the presented preview, and rendering the at least one imagery item in the selected template in a standardized video container file in response to receiving confirmation of the presented preview.

### CROSS-REFERENCE TO RELATED APPLICATIONS

The present application claims the benefit of co-pending U.S. provisional application No. 62/898,351, filed on Sep. 10, 2019, the entire disclosure of which is incorporated by reference as if set forth in its entirety herein.

### TECHNICAL FIELD

The present application generally relates to systems and methods for viewing imagery and, more particularly but not exclusively, to systems and methods for generating a preview of imagery that is stored in a particular location.

### BACKGROUND

People often like to view select portions or “previews” of gathered imagery. After organizing photographs or videos in a location such as a digital folder, a user may like to view a preview that corresponds to the contents of a folder. This preview may be a small video or a slideshow of pictures that correspond to contents of the folder. A user may therefore be reminded of the contents of the folder without needing to assign labels to the folder or without opening the folder to see the content therein. Users may similarly want to present this type of preview to their friends and family.

Existing media presentation services or software generally gather image imagery, select portions of the gathered imagery for use in a preview, render the imagery to a standardized imagery format, and then present the rendered preview to a user. These existing services and software are not efficient, however. They are resource intensive as they require the expenditure of computing resources to render a preview video. This inevitably increases processing load and consumes time. Additionally, these computing resources may be wasted as there is no guarantee that a user will be satisfied with the rendered preview.

A need exists, therefore, for systems and methods that overcome the disadvantages of existing media presentation services.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a method for presenting imagery. The method includes receiving at an interface at least one imagery item and a selection of a template; presenting to a viewer a preview of the at least one imagery item integrated in the selected template prior to rendering of the at least one imagery item in the template; receiving confirmation of the presented preview; and rendering the at least one imagery item in the selected template in a standardized video container file in response to receiving confirmation of the presented preview.

In some embodiments, the preview includes a visual of a plurality of imagery items.

In some embodiments, presenting the preview includes displaying the preview in a client-slide application executing on at least one of a desktop, personal computer, tablet, mobile device, and a laptop.

In some embodiments, the method further includes storing the rendered standardized video container file in at least one of a local file system and a cloud-based file system.

In some embodiments, the method further includes, after presenting the preview to the viewer, receiving at least one editing instruction from the viewer, updating the preview based on the at least one received editing instruction, and presenting the updated preview to the viewer. In some embodiments, the updated preview is presented to the viewer substantially in real time so that the viewer can observe effects of the editing instruction on the preview.

In some embodiments, the template is selected by a user.

In some embodiments, the template is selected from a plurality of templates associated with one or more third party template suppliers. In some embodiments, the template is selected from a plurality of templates associated with a third party supplier's template promotional campaign.

In some embodiments, the standardized video container file is rendered by a client-side application selected from the group consisting of a web-based client application and a mobile application.

According to another aspect, embodiments relate to a system for presenting imagery. The system includes an interface for receiving at least one imagery item and a selection of a template; memory; and a processor executing instructions stored on the memory and configured to generate a preview of the at least one imagery item integrated in the selected template prior to rendering of the at least one imagery item in the template, wherein the interface presents the preview to a viewer, receive confirmation of the presented preview, and render the at least one imagery item in the selected template in a standardized video container file in response to receiving confirmation of the presented preview.

In some embodiments, the preview includes a visual of a plurality of imagery items.

In some embodiments, the interface displays the preview in a client-slide application executing on at least one of a desktop, personal computer, tablet, mobile device, and a laptop.

In some embodiments, the rendered standardized video container file is stored in at least one of a local file system and a cloud-based file system.

In some embodiments, the processor is further configured to receive at least one editing instruction from the viewer, and update the preview based on the at least one received editing instruction, wherein the interface is further configured to present the updated preview to the viewer. In some embodiments, the updated preview is presented to the viewer substantially in real time so that the viewer can observe effects of the editing instruction on the preview.

In some embodiments, the template is selected by a user.

In some embodiments, the template is selected from a plurality of templates associated with one or more third party template suppliers. In some embodiments, the template is selected from a plurality of templates associated with a third party template supplier's promotional campaign.

In some embodiments, the standardized video container is rendered by a client-side application selected from the group consisting of a web-based client application and a mobile application.

### BRIEF DESCRIPTION OF DRAWINGS

Non-limiting and non-exhaustive embodiments of this disclosure are described with reference to the following figures, wherein like reference numerals refer to like parts throughout the various views unless otherwise specified.

FIG. 1 illustrates a system for presenting imagery in accordance with one embodiment;

FIG. 2 depicts a template selection page in accordance with one embodiment;

FIG. 3 depicts an imagery item selection page in accordance with one embodiment;

FIG. 4 illustrates the preview generator 114 of FIG. 1 in accordance with one embodiment;

FIG. 5 illustrates a viewer providing an editing instruction to update a preview in accordance with one embodiment;

FIG. 6 depicts a screenshot of a generated visual preview in accordance with one embodiment;

FIGS. 7A & B depict screenshots of photo selection window and an editing window, respectively, in accordance with one embodiment;

FIG. 8 depicts a flowchart of a method for presenting imagery in accordance with one embodiment; and

FIG. 9 depicts a screenshot of a confirmation window in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

The process of rendering refers to a process applied to an imagery item such as a photograph or video (for simplicity, “imagery item”) to at least enhance the visual appearance of the imagery item. More specifically, a rendering process enhances two- or three-dimensional imagery by applying various effects such as lighting changes, filtering, or the like. Rendering processes are generally time consuming and resource intensive, however.

As discussed previously, existing media presentation services or software generally gather imagery, select portions of the gathered imagery for use in a preview, render the imagery to a standardized imagery format, and then present the rendered preview to a user. However, these techniques expend computing resources to render the preview. This increases processing load and consumes time, and a viewer may ultimately decide they are not satisfied with the rendered preview.

The embodiments described herein overcome the disadvantages of existing media presentation services and software. Embodiments described herein provide systems and methods that enable users to view previews or simulations of imagery items without first fully rendering the preview. The systems and methods described herein may execute a set of software processes to output a video keepsake in a standardized video container format. The embodiments herein therefore improve the efficiency of rendering and presentation processes by achieving a rapid, high-fidelity preview of a video keepsake using web-based technologies, all prior to the actual rendering of the imagery item to a standardized video format.

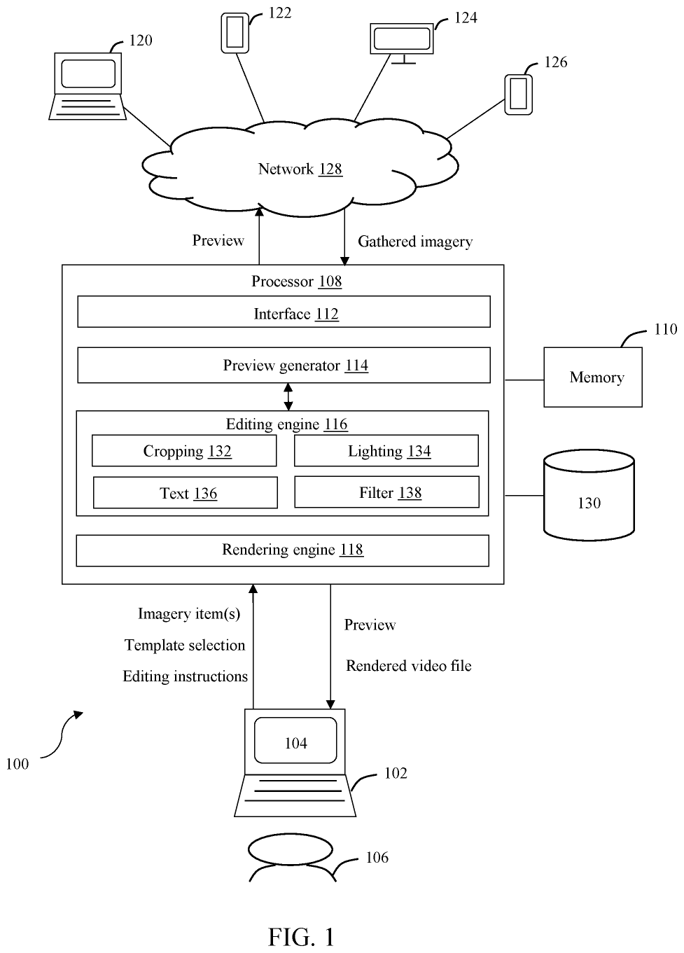

FIG. 1 illustrates a system 100 for presenting imagery in accordance with one embodiment. The system 100 may include a user device 102 executing a user interface 104 for presentation to a user 106. The user 106 may be a person interested in viewing a preview of imagery content that is stored in a location such as a digital file.

The user device 102 may be in operable connectivity with one or more processors 108. The processor(s) 108 may be any hardware device capable of executing instructions stored on memory 110 to accomplish the objectives of the various embodiments described herein. The processor(s) 108 may be implemented as software executing on a microprocessor, a field programmable gate array (FPGA), an application-specific integrated circuit (ASIC), or another similar device whether available now or invented hereafter.

In some embodiments, such as those relying on one or more ASICs, the functionality described as being provided in part via software may instead be configured into the design of the ASICs and, as such, the associated software may be omitted. The processor(s) 108 may be configured as part of the user device 102 on which the user interface 104 executes, such as a laptop, or may be located on a different computing device, perhaps at some remote location.

The processor(s) 108 may execute instructions stored on memory 110 to provide various modules to accomplish the objectives of the various embodiments described herein. Specifically, the processor 108 may execute or otherwise include an interface 112, a preview generator 114, an editing engine 116, and a rendering engine 118.

The memory 110 may be L1, L2, or L3 cache or RAM memory configurations. The memory 110 may include non-volatile memory such as flash memory, EPROM, EEPROM, ROM, and PROM, or volatile memory such as static or dynamic RAM, as discussed above. The exact configuration/type of memory 110 may of course vary as long as instructions for presenting imagery can be executed by the processor 108 to accomplish the features of various embodiments described herein.

The processor(s) 108 may receive imagery items from the user 106 as well as one or more participants 120, 122, 124, and 126 over one or more networks 128. The participants 120, 122, 124, and 126 are illustrated as devices such as laptops, smartphones smartwatches, and PCs, or any other type of device accessible by a participant.

The network(s) 128 may link the various assets and components with various types of network connections. The network(s) 128 may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network(s) 128 may also comprise, include, or interface to any one or more of a Wireless Application Protocol (WAP) link, a Wi-Fi link, a microwave link, a General Packet Radio Service (GPRS) link, a Global System for Mobile Communication G(SM) link, a Code Division Multiple Access (CDMA) link, or a Time Division Multiple access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based link.

The user 106 may have a plurality of live photographs, still photographs, Graphics Interchange Format imagery (“GIFs”), videos, etc. (for simplicity “imagery items”) stored across multiple folders on or otherwise accessible through the user device 102. These imagery items may include imagery items supplied by the one or more other participants 120-26.

As discussed previously, it may be difficult for the user 106 to remember which imagery items are stored and where. Similarly, it may be difficult for the user 106 to remember the content of a particular file, folder, or other digital location. In these situations, the user 106 may need to search through countless files to find a particular imagery item or thoroughly review folders to determine the content thereof. This may be time consuming and at the very least frustrate the user 106.

The embodiments herein may enable users to view previews or simulations of one or more imagery items without first fully rendering the preview. The processor(s) 108 may execute a set of software processes to output a video keepsake in a standardized video container format. The embodiments herein may therefore improve the efficiency of the rendering and presentation process by achieving a rapid, high-fidelity preview of the video experience using web-based technologies or 3D rendering engines (such as those originally intended for gaming)—all prior to rendering of the imagery items to a standardized video format. This preview may be presented to a view upon the viewer hovering a cursor over a folder, for example.

The system 100 of FIG. 1 therefore creates a preview keepsake without first rendering the preview. The system 100 of FIG. 1 addresses the disadvantages of existing techniques, as the system 100 and the methods implementing the system 100 do not render the preview until the user 106 is content with the preview. Once the user is content, the systems and methods may render the approved preview as a standardized video container file.

The database(s) 130 of FIG. 1 may not only store imagery items, but also a plurality of templates for use in the preview. These templates may be supplied by one or more third party template suppliers. These third parties may be professional photographers or videographers, for example. In operation, the systems and methods herein may use the supplied templates in generating a preview for the user 106. Certain templates may be made available as part of a supplier's promotional campaign, for example.

In some embodiments, templates may be associated with travel, holidays, themes, sports, colors, weather, or the like. This list is merely exemplary, and other types of templates may be used in accordance with the embodiments herein. Additionally, content creators or users may create and supply their own templates.

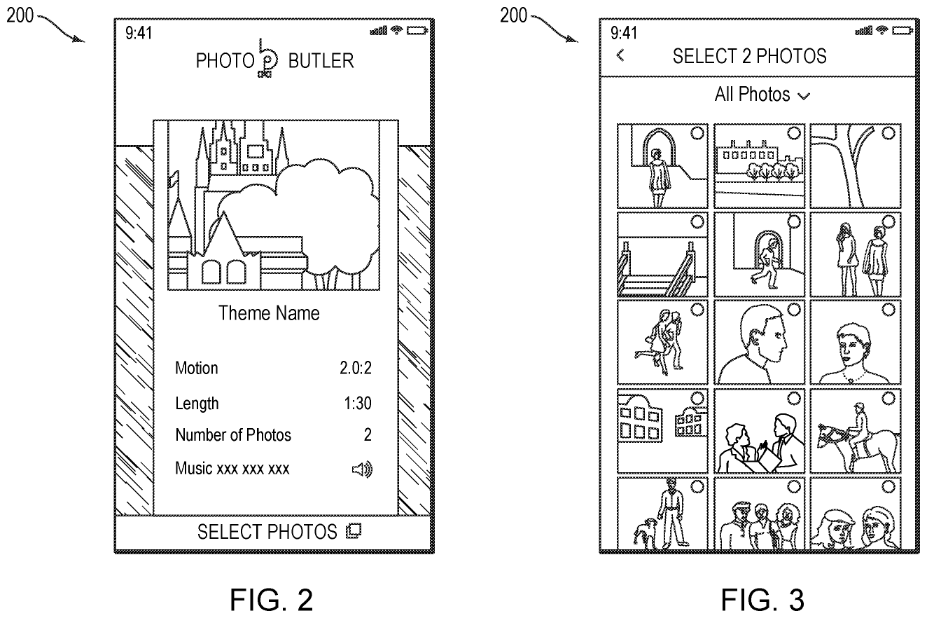

In operation, a user may select a template for use in generating the preview. FIG. 2, for example, illustrates an exemplary template selection page 200 that allows the user 106 to select a template for use in generating the preview. As can be seen in FIG. 2, the selection page 200 provides data regarding a particular template, and the user may adjust parameters such as the length of the preview, the number of photos in the preview, theme music, etc.

The interface 112 may receive one or more imagery items for use in a preview, as well as a selection of a template for use in generating the preview. For instance, the user 106 may select the “Select Photos” option on the selection page 200 to then select imagery items for use in the preview.

Professional video or photography editors may provide their own templates for use with the embodiments herein. These parties may upload a file containing templates to a designated server or database 130. To access the provided templates, the user 106 may access a designated application to download one or more of the uploaded templates. In some embodiments, the user 106 may be tasked with installing an application associated with a video or photography editor. The application can be, for example and without limitation, a link to a web site, a desktop application, a mobile application, or the like. The user 106 may install or otherwise access this application and provide the application with access to the user's selected imagery.

FIG. 3 presents an exemplary imagery selection page 300 that allows the user 106 to select one or more imagery items to be included in a preview. The user interface 104 may present this page 300 to the user 106 upon the user 106 selecting the “Select Photos” command shown in FIG. 2. In the embodiment shown in FIG. 3, the user 106 is prompted to select two (2) imagery items. The user 106 may then select two imagery items by, for example, contacting the user interface at portions corresponding to the desired imagery items.

The selected imagery items may be representative of several other imagery items stored in a particular file or location. For example, if a collection of imagery items are from a family's trip to Paris, a selected, representative imagery item may be of the Eiffel Tower. When this imagery item is subsequently presented to a user as part of a preview, the user is reminded of the other content in the file or particular location.

It is noted that the order in which the template and imagery items are selected may be different than outlined above. That is, a user 106 may first select which imagery item(s) are to be in the preview, and then select the template for the preview.

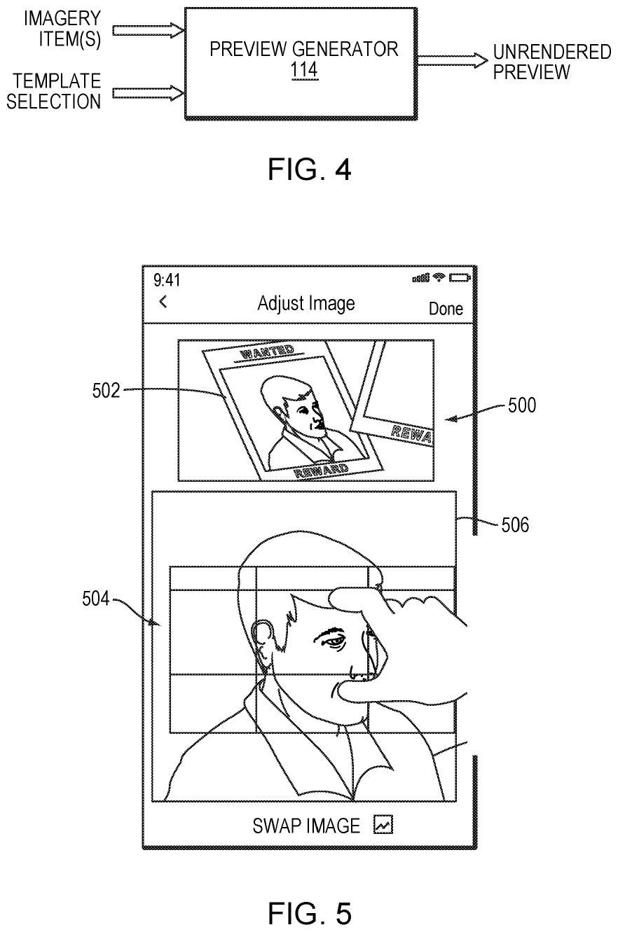

FIG. 4 illustrates the inputs and outputs of the preview generator 114 of FIG. 1 in accordance with one embodiment. As seen in FIG. 4, the preview generator 114 may receive one or more imagery items and a template selection as inputs. The preview generator 114 may process the selected template into a set of metadata attributes. The preview generator 114 may extract certain elements of data associated with the selected template(s) and integrate the selected imagery item(s) with the selected template.

The preview generator 114 may then output an interim, unrendered preview to the user 106. Not only does this provide the user 106 with an opportunity to review the preview, but also allows the user 106 to make edits prior to the rendering and creation of a standardized video container. For example, FIG. 5 illustrates an exemplary preview 500 in accordance with one embodiment. The preview 500 shows a picture of a person integrated in a template 502 which, in FIG. 5, is a “Wanted” poster.

FIG. 5 also illustrates an editing pane 504, which allows the user to make edits to the imagery item 506 as it is incorporated into the template 502. Referring back to FIG. 1, the editing engine 116 may execute various sub-engines to allow the user 106 to provide editing instructions. These may include, but are not limited to, a cropping engine 132 to allow the user 106 to crop the imagery item, a lighting engine 134 to allow the user 106 to provide various lighting effects, a text engine 136 to allow the user to provide text, and a filter engine 138 to allow the user 106 to apply one or more filters to the imagery item. These engines are only exemplary and other types of engines in addition to or in lieu of these engines may be used to allow the user 106 to edit the imagery item and the template.

For example, the user in FIG. 5 is using the editing pane 504 to crop the imagery item 506. The user may use their fingers to select and manipulate a cropping window 508 to select a portion of the imagery for use in the preview.

As the user provides these types of editing instructions, the preview generator 114 may update the preview 500 substantially in real time or as scheduled. Accordingly, the user can see how their editing instructions affect the preview.

The user may review the generated preview of one or more imagery item selections in, for example, a web-based player powered by a novel application of web technologies and real time, 3D rendering engines. These may include, but are not limited to, HTML, CSS, Javascript, or the like. Software associated with the preview generator 114 may generate the preview by applying novel machine learning processes to the user's imagery items and the selected template.

The user may then approve the preview for rendering once they are satisfied with the preview. In some cases, the user may not need to provide any editing instructions before indicating they are satisfied with the preview.

The rendering engine 118 of FIG. 1 may then render the imagery item and the template to generate the finished preview. The rendered preview may be stored in the user's local drive or to a location in a cloud-based storage system. The rendering engine 118 may be a client-side application selected from the group consisting of a web-based client application and a mobile application, for example. In some embodiments, the methods and systems described herein may rely on high performance, 3D engines such as those originally designed for gaming.

The rendering engine 118 may apply any one or more of a plurality of processes to apply various effects to the imagery item and/or the template. These effects may include, but are not limited to, shading, shadows, text-mapping, reflection, transparency, blurs, lighting diffraction, refraction, translucency, bump-mapping, or the like. The exact type of rendering processes executed by the rendering engine 118 may vary and may depend on the imagery item, template, editing instruction(s), and any other effect(s) to be applied.

The video container itself may be self-contained and include a combination of the imagery items and the template in, e.g., an MKV, OGG, MOV, or MP4 file that is playable by various third party applications on various computing devices that have no associated with the computer that creates the preview. By contrast, the unrendered preview involves, e.g., a computer displaying the template, and then positioning one or more imagery items at locations specified in the template to give the user a preview of the rendered object without actually performing the rendering. The user can change the inputs to the rendering engine 118 to change, e.g., the imagery item presented in the template before instructing the rendering engine 118 to finalize the combination, resulting in the video container.

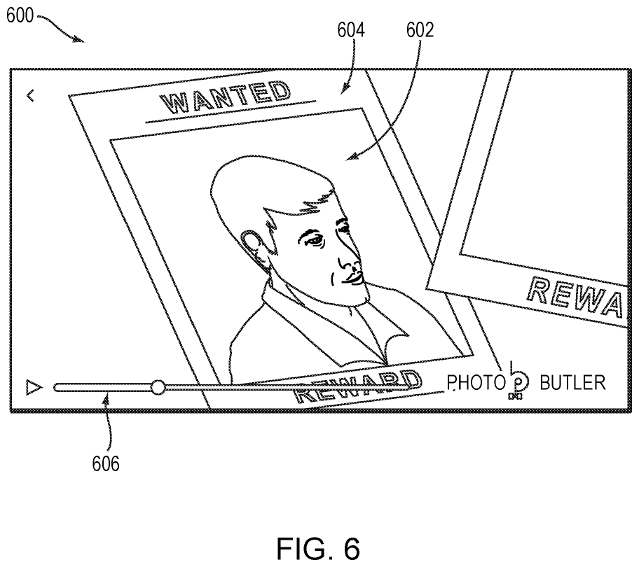

FIG. 6, for example, presents a screenshot of a rendered preview 600. As can be seen in FIG. 6, the preview 600 includes an imagery item 602 integrated into a template 604. The template 604 may be similar to the template 502 of FIG. 5, for example. The rendered preview 600 may be presented as a short video clip, as denoted by the video progress bar 606.

The preview may be presented to a user to inform the user of the contents of a particular file or location. For example, the user interface 104 of FIG. 1 may present the preview 600 to a user upon the user hovering their cursor over a folder containing the imagery in the preview 600. Accordingly, the user may get an idea of the contents of the folder (e.g., which imagery item(s) are in the folder) without opening the folder.

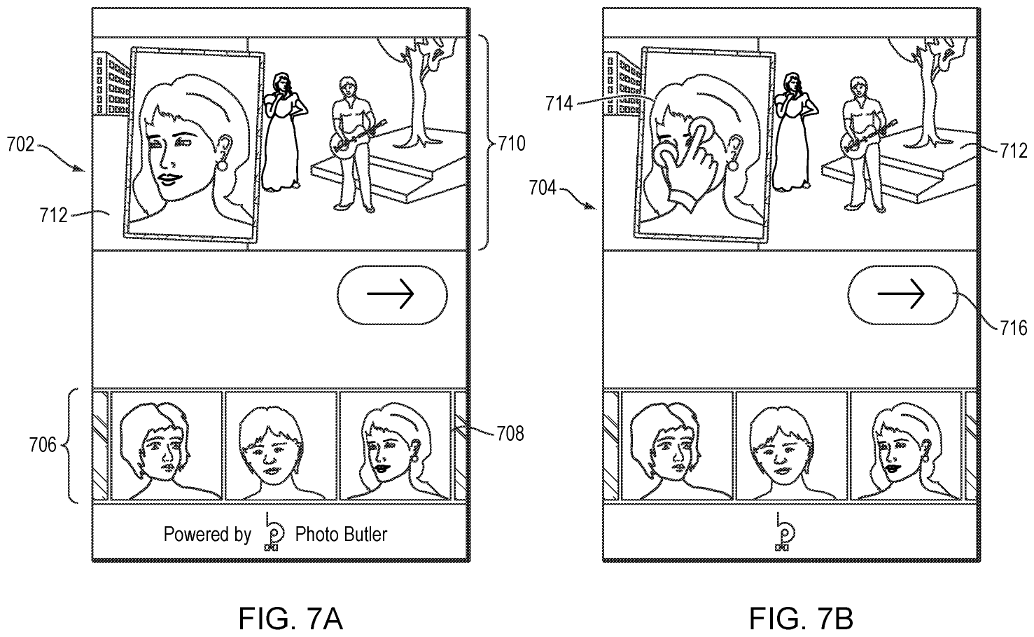

FIGS. 7A & B depict screenshots of a photo selection window 702 and an editing window 704, respectively, in accordance with another embodiment. The photo selection window 702 includes a selection pane 706 that may present a plurality of photos (and/or other types of imagery items) to a user. A border 708 may indicate that a particular photo has been selected. FIG. 7A also shows a preview window 710 that presents a selected photo integrated in a template 712.

The editing window 704 of FIG. 7B allows a user to then provide editing instructions such as those discussed previously. For example, the user in FIG. 7B is using a zoom tool 714 to change how the selected photo is presented in the template 712. That is, the user may manipulate or otherwise edit the photo directly in the template. Once the user is satisfied, they may select a confirmation button 716 to continue to the rendering stage.

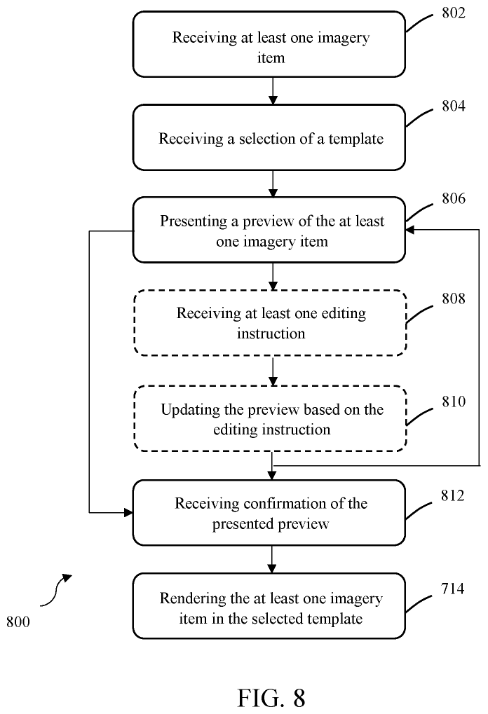

FIG. 8 depicts a flowchart of a method 800 for presenting imagery in accordance with one embodiment. The system 100 of FIG. 1 or components thereof may perform the steps of method 800.

Step 802 involves receiving at an interface at least one imagery item. The at least one imagery item may include still photographs, live photographs, GIFs, video clips, or the like. The imagery item(s) may be representative of a plurality of other imagery items in a certain collection, such as a folder.

Step 804 involves receiving at the interface a selection of a template. A user may select a template from a plurality of available templates for use in generating a preview. These templates may be associated with certain themes (e.g., birthday parties, a destination wedding in a specific location, a trip to a particular resort) and may be provided by one or more third party template suppliers. These suppliers may be professional videographers or photographers, for example.

Step 806 involves presenting to a viewer a preview of the at least one imagery item integrated in the selected template prior to rendering of the at least one imagery item in the template. For example, an interface such as the user interface 104 of FIG. 1 may present how an imagery item would appear within the template. This is done before any rendering occurs. That way, the systems and methods described herein do not expend computing resources by rendering a preview before a user confirms they are satisfied with the preview.

Step 808 involves receiving at least one editing instruction from the viewer. As discussed previously, a user may provide one or more edits to the preview to, for example, adjust how the imagery item is displayed. The user may crop the imagery item, change lighting settings, provide filters, provide text overlays, provide music to accompany the preview, provide visual effects, or the like. This list of edits are merely exemplary and the user may make other types of edits in addition to or in lieu of these types of edits, such as replacing the selected imagery item with another imagery item.

Step 810 involves updating the preview based on the at least one received editing instruction. A preview generator such as the preview generator 114 of FIG. 1 may receive the user-provided editing instructions and update the preview accordingly. These updates may be made and presented to the user in at least substantially real time so a user can see how their edits will affect the preview. This is seen in FIG. 8, as the method 800 proceeds from step 810 back to step 806. The now-updated preview is then presented to the user.

Step 812 involves receiving confirmation of the presented preview. If the user is satisfied with the preview, they may confirm the preview should be rendered. The user may be presented with a prompt such as, “Are you satisfied with the generated preview?” and they may provide some input indicating they are satisfied with the preview. If they are not satisfied, they may continue to edit the preview, select a different template, or the like.

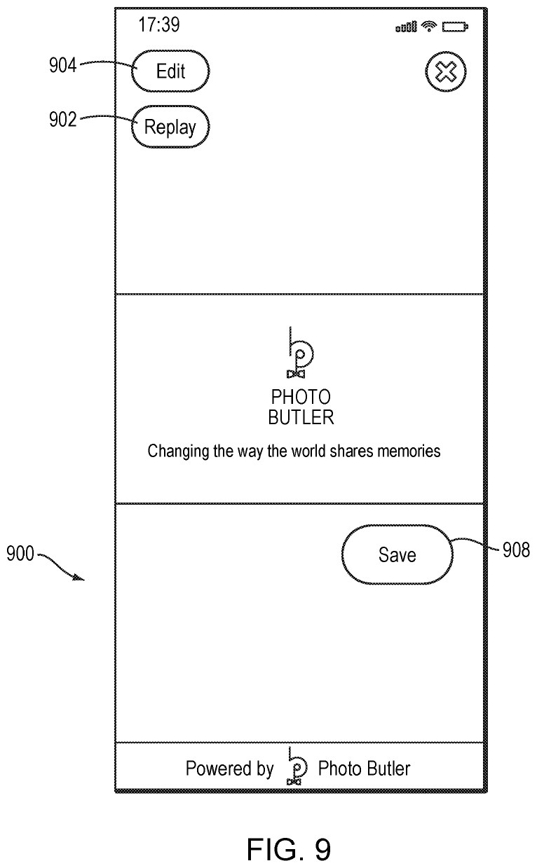

For example, FIG. 9 depicts a screenshot of a confirmation window 900 that may be presented to a user. The user may select a replay button 902 to view a replay of the preview, and edit button 904 to further edit the preview, or a save button 906 to save and render the preview.

Step 814 involves rendering the at least one imagery item in the selected template in a standardized video container file in response to receiving confirmation of the presented preview. Once rendered in a standard video container file, the systems and methods herein may save the rendered imagery item to the user's local drive or to another location such as on a cloud-based storage system.

The systems and methods described herein achieve a number of advantages over existing techniques for presenting imagery. First, a video or photography editor can create an initial template to control the user's experience in a highly detailed way using off-the-shelf, template creation software. Second, a preview generator such as the preview generator 114 of FIG. 1 increases the efficiency of the preview creation process as it allows for faster iterations than standard video creation workflows. Third, the preview generator 114 of the embodiments herein is secure from piracy as it is composed of web technologies or 3D rendering engines as opposed to standard video formats. Fourth, a mobile application can render the visual preview at the client and not at a server. This provides the user with privacy, as the preview is created on their own device first.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for presenting imagery, the method comprising:
receiving at an interface:
at least one imagery item, and
a selection of a template;
presenting to a viewer a preview of the at least one imagery item integrated in the selected template prior to rendering of the at least one imagery item in the template;
receiving confirmation of the presented preview; and
rendering the at least one imagery item in the selected template in a standardized video container file in response to receiving confirmation of the presented preview.

2. The method of claim 1 wherein the preview includes a visual of a plurality of imagery items.

3. The method of claim 1 wherein presenting the preview includes displaying the preview in a client-slide application executing on at least one of a desktop, personal computer, tablet, mobile device, and a laptop.

4. The method of claim 1 further comprising storing the rendered standardized video container file in at least one of a local file system and a cloud-based file system.

5. The method of claim 1 further comprising, after presenting the preview to the viewer:
receiving at least one editing instruction from the viewer,
updating the preview based on the at least one received editing instruction, and
presenting the updated preview to the viewer.

6. The method of claim 5 wherein the updated preview is presented to the viewer substantially in real time so that the viewer can observe effects of the editing instruction on the preview.

7. The method of claim 1 wherein the template is selected by a user.

8. The method of claim 1 wherein the template is selected from a plurality of templates associated with one or more third party template suppliers.

9. The method of claim 8 wherein the template is selected from a plurality of templates associated with a third party supplier's template promotional campaign.

10. The method of claim 1 wherein the standardized video container file is rendered by a client-side application selected from the group consisting of a web-based client application and a mobile application.

11. A system for presenting imagery, the system comprising:
an interface for receiving:
at least one imagery item, and
a selection of a template;
memory; and
a processor executing instructions stored on the memory and configured to:
generate a preview of the at least one imagery item integrated in the selected template prior to rendering of the at least one imagery item in the template, wherein the interface presents the preview to a viewer,
receive confirmation of the presented preview; and
render the at least one imagery item in the selected template in a standardized video container file in response to receiving confirmation of the presented preview.

12. The system of claim 11 wherein the preview includes a visual of a plurality of imagery items.

13. The system of claim 11 wherein the interface displays the preview in a client-slide application executing on at least one of a desktop, personal computer, tablet, mobile device, and a laptop.

14. The system of claim 11 wherein the rendered standardized video container file is stored in at least one of a local file system and a cloud-based file system.

15. The system of claim 11 wherein the processor is further configured to:
receive at least one editing instruction from the viewer, and
update the preview based on the at least one received editing instruction, wherein the interface is further configured to present the updated preview to the viewer.

16. The system of claim 15 wherein the updated preview is presented to the viewer substantially in real time so that the viewer can observe effects of the editing instruction on the preview.

17. The system of claim 11 wherein the template is selected by a user.

18. The system of claim 11 wherein the template is selected from a plurality of templates associated with one or more third party template suppliers.

19. The system of claim 18 wherein the template is selected from a plurality of templates associated with a third party template supplier's promotional campaign.

20. The system of claim 10 wherein the standardized video container is rendered by a client-side application selected from the group consisting of a web-based client application and a mobile application.
